(19) United States
(12) Patent Application Publication
(10) Pub. No.: US 2003/0060185 A1
(43) Pub. Date: Mar. 27, 2003

(54) Wireless control and/or data acquisition system in an integrated circuit package

(76) Inventors: Richard J. Fisher, Glendale, AZ (US); Roger D. St. Amand, Tempe, AZ (US); Steven R. Bible, Chandler, AZ (US); Johannes A. Van Niekerk, Tempe, AZ (US); Farron L. Dacus, Chandler, AZ (US)

Correspondence Address: BAKER BOTTS, LLP, 910 LOUISIANA, HOUSTON, TX, 77002-4995, US

(21) Appl. No.: 09/953,058

(22) Filed: Sep. 14, 2001

(51) Int. Cl. H04B 1/06

(52) U.S. Cl. 455/344; 455/130

(57) ABSTRACT

A wireless control and/or data acquisition system in an integrated circuit comprises a digital device and a wireless device, e.g., a radio frequency (RF) device, an infrared device (IrDA), etc. A micro-electro-mechanical (MEM) device may also be included in the integrated circuit package. The MEM may be used as a sensor, non-volatile memory, a filter, a frequency determining resonator, and/or a control device in combination with the digital device. The digital device and RF device may have independent power and signal connections for signal isolation between the digital device and RF device. Standby and sleep modes for the digital device and RF device reduce power consumption and low voltage operation enables the use of a simple battery power source.

### RELATED APPLICATION

The application is related to co-pending application Ser. No. ______, entitled “Functional Pathway Configuration at a System/IC Interface” by Roger D. St. Amand, Steven R. Bible, Richard J. Fisher, Johannes A. van Niekerk, and Farron L. Dacus, filed ______, and is hereby incorporated by reference for all purposes.

### FIELD OF THE INVENTION

The present invention relates generally to status and control of digital logic circuits in a wireless environment, e.g., electromagnetic radio frequency and lightwave, and acoustic sound waves and more particularly, to a wireless digital device adapted for radio frequency or infrared communications and having control, data acquisition, code hopping decoder, code hopping encoder, and/or code hopping encoder-decoder capabilities.

### BACKGROUND OF THE INVENTION

Consumer and industrial products are functioning more and more in a wireless environment. The wireless environment may be characterized as any type of transmission medium not requiring a direct connection of wires or optical conduit (optically transmissive glass or plastic fiber) for the conveyance of information. These wireless products may be used in a variety of applications where the wireless capability is a requirement, convenience and/or cost saving feature. Some typical applications are control and security, telemetry and radio frequency (RF) identification, e.g., garage door openers, vehicle and building keyless entry systems, vehicle tire parameter monitoring, security system sensors, patient monitoring, process monitoring and control systems, and inventory tracking. In addition to RF, infrared and ultrasonic transmission mediums and the like may be used for shorter range communications.

Security systems use various types of sensors, e.g., magnetic switched contacts, vibration (glass breakage), ultrasonic, infrared detection of motion or heat, remote keyless entry, etc. Data acquisition and control systems may use process parameter sensors, e.g., temperature, pressure, pH, flow-rate, vibration, current, voltage, resistance, etc. In addition, actuation and/or control circuits may be used in a process system. Actuation circuits may be electrical contact closure, current or voltage levels, analog current or voltage values, etc. Generally, these sensors and control circuits are external to the transmission and/or reception electronics.

Wireless RF products range from low cost inductance-capacitance (LC) tuned circuit and Surface Acoustic Wave (SAW) devices to Phase Locked Loop (PLL) and frequency-locked-loop based frequency control. SAW based frequency stabilization has encouraged greater use of wireless products but PLL based wireless products are superior in performance because of their greater frequency stability which allows narrower bandwidth receivers having better signal to noise ratios and thus greater operating range and data transfer reliability.

Another rapidly growing use of wireless products is in wireless computer networking. The Bluetooth consortium, HomeRF and Zigbee are addressing the need for wireless computer networking. The IEEE 802.15 Working Group for WPANs (Wireless Personal Area Networks) is also trying to establish standards for wireless products. An IrDA working group has established standards for infrared communications between different manufacturers products.

In the age of digital communications and wireless digital networks, e.g., Bluetooth, HomeRF and Zigbee (RF) and IrDA (infrared), intelligent control is becoming a necessity. Digital devices, e.g., microprocessor and microcontroller, programmable logic array (PLA), application specific integrated circuit (ASIC) have been put to use as communications controllers in combination with the transmission medium devices, e.g., RF or optical receivers and transmitters. However, these communications controllers are specialized single use devices requiring the wireless product to utilize separate digital electronic circuits, e.g., microprocessor, microcontroller, programmable logic array (PLA), application specific integrated circuit (ASIC) and the like for processing of the wireless product's application.

High end applications of wireless products, e.g., Bluetooth, generally are high in cost and power consumption, and thus are not appropriate for price sensitive and/or battery operated wireless products.

In radio frequency controlled wireless products, ranges used may vary by application, e.g., 400 MHz for control and security; European 868-870 MHz and U.S. 902-928 MHz Industrial, Scientific and Medical (ISM) bands, and worldwide 2400-2483.5 MHz ISM bands. Various power levels may be used depending on the application and range desired. Short duration intermittent transmissions are required by the FCC rules in the U.S.A., and in Europe by the European radio authorities. Low power, short duration transmissions are desirable for conserving battery power of the wireless product. Further conservation of battery power may be realized by putting the wireless product into a “sleep mode” until activation, operation and/or transmission. More commercial and industrial products would be wireless if the cost and power consumption could be reduced, and reliability and performance increased.

What is needed is a low cost, compact, reliable, rugged, low power, easily configurable and programmable, and operationally powerful wireless device adapted for use in a broad range of commercial and industrial wireless products.

### SUMMARY OF THE INVENTION

The present invention may address one or more of the problems set forth above. Certain possible aspects of the present invention are set forth below as examples. It should be understood that such aspects are presented simply to provide the reader with a brief summary of certain forms the invention might take, and that these aspects are not intended to limit the scope of the invention. Indeed, the invention may encompass a variety of aspects that may not be set forth below. The present invention comprises a digital device and a radio frequency (RF) device (e.g., a receiver, transmitter or transceiver) in a single integrated circuit package. Connections to the digital device and radio frequency device are provided within the integrated circuit (IC) package, or via pin to pin connections that are external to the IC package. In addition, a micro-electro-mechanical (MEM) device may be incorporated into the single integrated circuit package and adapted for connection to the digital device and an external process. The MEM may be used as a sensor, non-volatile memory, a filter, a frequency determining resonator, and/or a control device in combination with the digital device. The single integrated circuit package may also include an antenna, a plurality of sensors, such as a plurality of MEMs, and/or a crystal or other type of frequency determining device.

It is contemplated and within the scope of the present invention that the digital device may be any digital logic circuit, e.g., a microcomputer, programmable logic array (PLA), application specific integrated circuit (ASIC), code hopping encoder, code hopping decoder, code hopping encoder-decoder, etc. Any type of wireless transmission and/or reception device, e.g., infrared, ultrasonic, xray, laser, magnetic, etc., may be used in place of the RF device, wherein the digital device, the wireless device and/or the MEM device(s) may be contained in the single integrated circuit package. It is also contemplated and within the scope of the present invention that embodiments thereof may have data acquisition capabilities, analog and/or digital, e.g., pressure, temperature, vibration, flow-rate, current, voltage, resistance, pH, magnetic, gyroscopic, gravity, etc.

In an exemplary embodiment of the present invention, a digital device may have a plurality of digital inputs and outputs, a clock input and output, a serial data output, analog inputs, analog outputs, and be adapted for connection to power (V_{DD}) and ground (V_{SS}). The digital device may be a reduced instruction set computer (RISC) and may have non-volatile memory, e.g., electrically programmable read only memory (EPROM) and/or electrically erasable and programmable read only memory (EEPROM or FLASH) in addition to random access memory (RAM). These types of memory (EPROM, EEPROM or FLASH) allow security codes such as rolling codes to be retained in the embodiments of the present invention when power is removed therefrom. A more detailed description of rolling security codes may be found in commonly owned U.S. Pat. Nos. 5,675,622; 6,166,650; 6,175,312; and 6,191,701 which are incorporated herein for all purposes. Other forms of encryption, error correction, collision detection and anti-collision operation are contemplated herein and may be used with various embodiments of the invention. The embodiments of the present invention in a product may also benefit from other functions, features and advantages of a digital device (digital logic circuit) but without having to run power and control wiring thereto.

In another exemplary embodiment, one or more micro-electro-mechanical (MEM) devices may be included with the digital device and RF device in the integrated circuit package. A MEM may be an electrical switch consisting of a cantilever, an embedded planar coil, a permanent magnet, and electrical contracts. The MEM cantilever may be a two-layer composite of a soft magnetic material, e.g., NiFe permalloy, on its topside and a conductive material at both sides. The cantilever is supported by torsion flexures from the two sides. The contact end of the cantilever can be deflected up or down by applying a current through the coil. When the cantilever is in the “down” position, it makes contact to a bottom conductor and the switch is “on” or “closed.” When the contact end of the cantilever is “up” the switch is “off” or “open.” The permanent magnet holds the cantilever in either the “up” or “down” position after switching occurs, making the MEM a latching relay. An exemplary MEM called MagLatch (tm) is manufactured by Microlab, 341 East Alamo Drive, Chandler, Ariz. 85225, and is incorporated by reference herein.

Other switch or relay configurations are possible as well as optical switches. Pressure and vibration sensors are possible using the MEM technology. Other types of sensors, e.g., RTD, thermocouple, etc., and/or actuators may be included in the integrated circuit package.

RF and intermediate frequency (IF) filters, and a crystal or ceramic resonator stabilized oscillator may be used as well as a MEM resonator for determining the frequency of the RF signal.

In the exemplary embodiments of the invention, the RF device may be a single or multiple channel (frequency) phase locked loop (PLL) transmitter, receiver or transceiver with an integrated crystal oscillator and voltage controlled oscillator (VCO) for operation of the PLL. A PLL loop filter and frequency divider may also be provided within the RF device. Multiple frequency capabilities may be utilized in a cellular, PCS, and/or spread spectrum communications system. Both the digital device and RF device may be adapted for simple, low cost single-cell battery operation in the two to three volt range and further may be adapted to enter a very low power sleep mode when not operational.

The RF device may also be frequency agile to allow multiple links to co-exist in the same area of use without interference therebetween. Frequency agility also allows for the avoidance of multi-path fading by switching to an alternate frequency. Frequency agility is also necessary for implementing frequency hopping spread spectrum communication systems. All types of modulation techniques are contemplated herein, such as, amplitude shift keying (ASK), frequency shift keying (FSK), phase shift keying (PSK), etc. Additionally, data transmission techniques such as parity and forward error correction of the digital information are contemplated herein. An RF device receiver may advantageously include a data slicer, internal synchronization capabilities, etc.

In one aspect, the present invention comprises a single package containing a radio frequency device and a digital device including a plurality of connections or “pins.” For the digital device, at least one pin comprises a power connection, at least one pin comprises a ground connection, and the remaining pins are input, output or input/output (I/O) connections, wherein each pin may have one or more associated functions. The pins may be analog, digital, mixed-signal (can be analog or digital). Some pins advantageously may be multiplexed with one or more alternate functions for the peripheral features on the digital device so that in general when a function is enabled that particular pin may not be used, for example, as a general purpose I/O pin. Separate pins for radio frequency signals, power and ground for the radio frequency device may be used in embodiments of the present invention. Having separate power and ground connections for the digital device and the RF device provides easier and more reliable isolation of digital, analog and RF signals. Differential antenna connections may be provided and adapted for a loop antenna configuration.

In accordance with the present invention, the integrated circuit, with which a system interfaces, comprises a packaged IC. Examples of types of packaging include, but not limited to a dual in-line package (DIP), which may comprise, but is not limited to molded plastic dual in-line package (PDIP) or ceramic dual in-line package (CERDIP); micro lead frame (MLF); pin grid arrays (PGAs); ball grid arrays (BGAs); quad packages; thin packages, such as flat packs (FPs), thin small outline packages (TSOPs), shrink small outline package (SSOP), small outline IC (SOIC) or ultrathin packages (UTPs); lead on chip (LOC) packages; chip on board (COB) packages, in which the chip is bonded directly to a printed-circuit board (PCB); and others.

Exemplary embodiments of integrated circuit package connections or “pinouts” for the present invention are more fully described in co-pending application Ser. No. ______, entitled “Functional Pathway Configuration at a System/IC Interface” by Roger D. St. Amand, Steven R. Bible, Richard J. Fisher, Johannes A. van Niekerk, and Farron L. Dacus, filed ______, 2001, and is incorporated by reference herein for all purposes.

The present invention is directed to a wireless RF digital system in a single integrated circuit package, said system comprising a digital device, a wireless RF device and a single integrated circuit package, wherein said digital device and wireless RF device are within said single integrated circuit package. The present invention is also directed to a digital device, a wireless RF device, and a MEM device in a single integrated circuit package. The present invention is further directed to a digital device, a wireless RF device, a MEM device, and a crystal or a ceramic frequency resonator in a single integrated circuit package.

The present invention is also directed to a method for wireless RF control of a digital system, said method comprising the steps of providing a digital device and a wireless RF device in a single integrated circuit package, processing input data with the digital device, and transmitting the processed input data with the wireless RF device.

A feature of the present invention is a wireless RF device and a digital device in an integrated circuit package.

Another feature is a low power sleep mode for the digital device.

Another feature is a low power sleep mode for the RF device.

Another feature is a low power sleep mode for the digital device and RF device.

Another feature is encryption of data with a digital device before transmission thereof by a RF device.

Another feature is determining transmission frequency using a PLL and an oscillator using a crystal or a ceramic resonator for its frequency determining element.

Another feature is determining data rate with a crystal oscillator.

An advantage of the present invention is separate power and ground connections to a digital device and a RF device in an integrated circuit package.

Another advantage is an analog-to-digital converter (ADC) in combination with the digital device and RF device in a single integrated circuit package.

Another advantage is the combination of a digital device, an RF device, a MEM device, and an oscillator using a crystal or a ceramic resonator.

Another advantage is enhanced isolation between analog and digital signals to and from a digital device and signals from a RF device, both the digital device and RF device being in the same integrated circuit package.

Another advantage is selection of different digital devices and/or RF devices in an integrated circuit package.

Another advantage is very low power usage when in a standby or sleep mode.

Features and advantages of the invention will be apparent from the following description of the embodiments, given for the purpose of disclosure and taken in conjunction with the accompanying drawings.

### BRIEF DESCRIPTION OF THE DRAWINGS

Further objects and advantages of the present invention will become apparent upon reading the following detailed description and upon referring to the accompanying drawings in which:

FIG. 1 is a functional block diagram illustrating an exemplary embodiment of the present invention;

FIGS. 2a and 2b are diagrams illustrating exemplary embodiments of 18-pin and 20-pin integrated circuit packages containing radio frequency devices and digital devices, respectively, including functional pathway configurations for the interface between the radio frequency device and digital device, and a system in which they are embedded, in accordance with the exemplary embodiment of FIG. 1;

FIG. 3 is a schematic circuit diagram of an exemplary embodiment of the invention.

FIG. 4 is a functional block diagram illustrating another exemplary embodiment of the present invention having a micro-electro-mechanical (MEM) device.

FIG. 5 is a functional block diagram illustrating still another exemplary embodiment of the present invention having a process sensor included in the integrated circuit package.

FIG. 6 is a functional block diagram illustrating still another exemplary embodiment of the present invention having a frequency determining device included in the integrated circuit package.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

The description below illustrates exemplary embodiments of the present invention. For the sake of clarity, not all features of an actual implementation of the present invention are described in this specification. It should be appreciated that in connection with developing any actual embodiment of the present invention many application-specific decisions must be made to achieve specific goals, which may vary from one application to another. Further, it should be appreciated that any such development effort might be complex and time-consuming, but would still be routine for those of ordinary skill in the art having the benefit of this disclosure.

For the sake of clarity and convenience, aspects of the present invention are described in the context of various embodiments typically used in applications generally involving a digital device and radio frequency device in an integrated circuit package (hereinafter “wireless digital device package”), examples of which are set forth herein. In addition, micro-electo-mechanical (MEM) devices, process sensors and/or a crystal or ceramic resonator frequency controlled oscillator may be included in the wireless RF device and digital device package.

Referring now to the drawing, the details of exemplary embodiments of the present invention are schematically illustrated. Like elements in the drawing will be represented by like numbers, and similar elements will be represented by like numbers with a different lower case letter suffix.

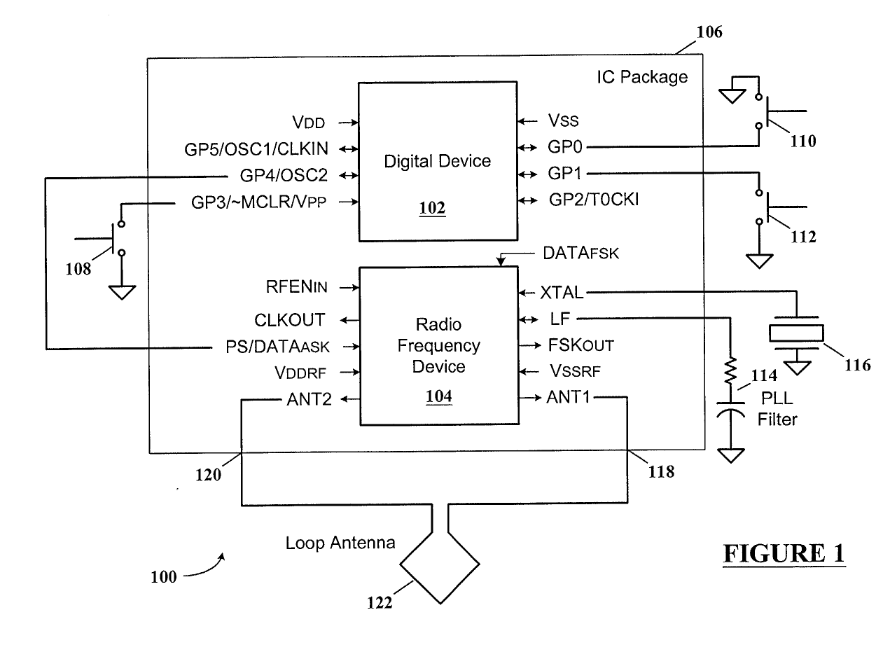

Referring to FIG. 1, illustrated is a functional block diagram of an exemplary embodiment of the present invention. A wireless RF device and digital device in a single integrated circuit package is generally indicated by the numeral 100. The wireless RF device and digital device package 100 comprises a digital device 102 and a radio frequency device 104 in an integrated circuit package 106. For clarity the digital device 102 is shown with eight pins, but may include many more pins, e.g., 100 or more, or have as few as three pins. The digital device 102 is functionally configured with a plurality of bi-directional input-outputs (I/O) (e.g., GP0, GP1, GP2, GP3, GP4 and GP5). Some or all of which may be capable of multiple functions, e.g., master clear (reset) or serial programming data input (GP3/˜MCLR/V_{PP}), clock buffer or crystal oscillator (GP5/OSC1/CLKIN), crystal frequency output (GP4/OSC2), and serial data clock (GP2/T0CKI). Digital power V_{DD} and ground V_{SS} are also brought out to separate connections on the package 106. Various digital inputs, e.g., switches 108, 110 and 112, contact sensors (not shown), etc., may be coupled to the I/O of the digital device 102 through connections on the package 106.

Regarding the RF device 104, addition pin connections for a phase-locked-loop filter 114, antenna outputs 118 and 120, power select/amplitude shift keying data input

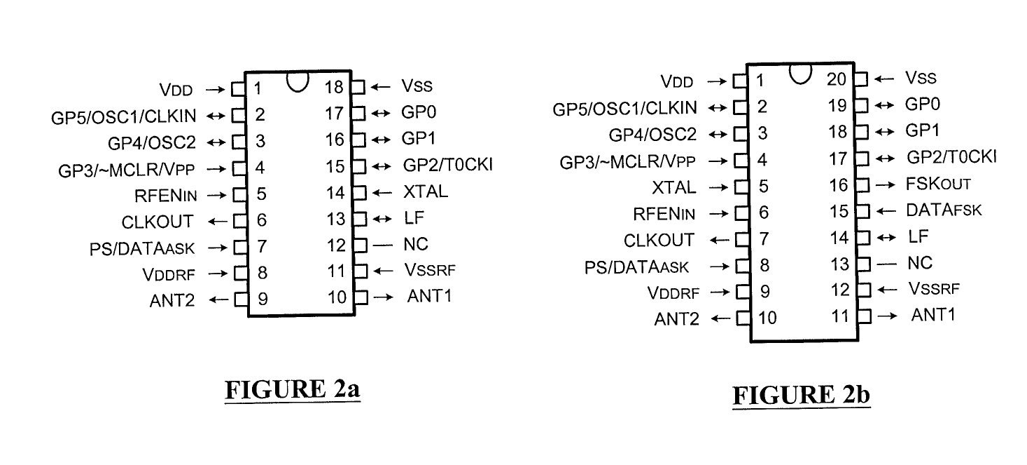

(PS/DATAASK), and isolated power (V_{DDRF}) and ground (V_{SSRF}) connects are provided on the package 106. The connection pins associated with the digital device 102 preferably are grouped together on both sides of a vertical axis along a length of a portion of the package 106 (as opposed to across the package). Likewise, the connection pins associated with the radio frequency device 104 preferably are grouped together on both sides of the vertical axis along the length of the remaining portion of the package 106. A configuration including such a feature has as an advantage an increased ability to simplify routing for system board design and integrated circuit radio frequency digital device placement therein. Such advantage may prove beneficial in some cases, e.g., to an applications engineer in situations where partitioning of the printed circuit board in which the digital device is to be mounted would prove to be advantageous. In the embodiment shown, the locations of the ANT 1 and ANT 2 pins 118 and 120, respectively, are at one end of the package 106 and are symmetrically placed to enable convenient placement of an antenna, e.g., a loop antenna 122 on the product board (not shown). The RF device 104 ground or common power supply pins, V_{SS} and V_{SSRF} are grouped on one side of the package 106. The power supply pins, V_{DD} and V_{DDRF} are grouped on the other side of the package 106. Further, as illustrated in FIGS. 2a and 2b, the pins associated with the radio frequency device 104 are grouped together and the pins associated with the digital device 102 are advantageously grouped together for simplification of board layout and signal integrity. A crystal 116 may be used for enhanced frequency stability of the RF device 104. The RF device 104 may be a receiver, transmitter or transceiver (receive and transmit), and may operate at any frequency assigned to low power devices.

The GP5/OSC1/CLKIN functional pathway is adapted for coupling as a bi-directional I/O port, oscillator crystal input or external clock input of the system. The GP4/OSC2 functional pathway is adapted for coupling as a bi-directional I/O port or oscillator crystal output. The GP3/˜MCLR/V_{PP} functional pathway is adapted for coupling as an input port, master clear (reset) input or programming voltage input. The RFen functional pathway is adapted for coupling as a dual enable for clock buffer and RF activation. The CLKOUT functional pathway is adapted for coupling as a crystal frequency divided by N, e.g., four. The PS/DATAASK functional pathway is adapted for coupling as a power select and amplitude shift keying (ASK) input. The ANT 1 and ANT 2 functional pathways are adapted for coupling to either a single ended or differential antenna. The LF (Loop Filter) functional pathway is adapted for coupling to a common node of charge pump output and VCO steering input, this pathway is an external loop filter connection. The XTAL (Xtal OSC) functional pathway is adapted for coupling as an external crystal connection. The GP2/T0CKI functional pathway is adapted for coupling as a bi-directional I/O port, or may be configured as T0CKI. The GPO functional pathway is adapted for coupling as a bi-directional I/O port or serial programming data. The GP1 functional pathway is adapted for coupling as a bi-directional I/O port or serial programming clock. The V_{DD} and V_{SS} functional pathways are adapted for coupling to power supply voltages required for operation of the digital device in the system. The V_{DDRF} and V_{SSRF} functional pathways are adapted for coupling to power supply voltages required for operation of the radio frequency device in the system.

Referring to FIGS. 2a and 2b, exemplary embodiments of the wireless digital device package 100 in accordance with the present invention comprise a plastic small outline integrated circuit (SOIC) or a shrink small outline package (SSOP) 18-pin and 20-pin, respectively.

Table 1 describes an exemplary embodiment including the various functions that the wireless RF device and digital device package 100 may perform, with the functions arranged by pin dedication. Of course the exact pin and function names used in any particular embodiment or application may vary depending upon the naming convention(s) selected. The embodiment described in Table 1 in general may be suited for applications requiring a wireless RF device 104 and digital device 102 in an 18 pin integrated circuit package 106.

TABLE 1

| | Input/Output/ | BUFFER | |
|---|---|---|---|
| PIN NO./NAME | Power | TYPE | DESCRIPTION |
| 1. V_{DD} | Power | N/A | Positive supply for |
| | | | logic and I/O pins, |
| | | | 2.5 to 5.5 volts. |
| 2. GP5/OSC1/CLKIN | Input/Output | TTL/ST | Bi-directional I/O |
| | | | port/oscillator |
| | | | crystal input/ |
| | | | external clock input. |
| 3. GP4/OSC2 | Input/Output | TTL | Bi-directional I/O |
| | | | port/oscillator |
| | | | crystal output. |
| 4. GP3/˜MCLR/V_{PP} | Input | TTL/ST | Input port/master |
| | | | clear (reset) input/ |
| | | | programming |
| | | | voltage input. |
| 5. RFEN_{IN} | Input | CMOS | Dual enable for |
| | | | clock buffer and RF |
| | | | (no hysteresis). |
| 6. CLKOUT | Output | CMOS | Crystal Frequency |
| | | | divided by N, e.g., |
| | | | four. |
| 7. PS/DATA_{ASK} | Input | CMOS | Power Select and |
| | | | ASK input. |
| 8. V_{DDRF} | Power | N/A | Radio frequency |
| | | | device power. |
| 9. ANT2 | Output | NPN | Antenna output2. |
| | | Collector | |
| 10. ANT1 | Output | NPN | Antenna output1 |
| | | Collector | |
| 11. V_{SSRF} | Power | N/A | Radio frequency |
| | | | device ground |
| 12. No Connection | N/A | N/A | |
| 13. LF (Loop Filter) | Output | N/A | Common node of |
| | | | charge pump |
| | | | output and VCO |
| | | | steering input, |
| | | | external loop |
| | | | filter connection. |
| 14. XTAL (Xtal OSC) | Input | Xtal | Crystal oscillator |
| | | OSC base | connection. |
| 15. GP2/T0CKI | Input/Output | ST | Bi-directional I/O |
| | | | port. Can be |
| | | | configured |
| | | | as T0CKI. |
| 16. GP1 | Input/Output | TTL/ST | Bi-directional I/O |
| | | | port/serial |
| | | | programming clock. |
| 17. GP0 | Input/Output | TTL/ST | Bi-directional I/O |
| | | | port/serial |
| | | | programming data. |
| 18. V_{SS} | Power | N/A | Digital logic and I/O |
| | | | pins ground |

Legend:
TTL = TTL compatible input; I = input; P = power; ST = Schmitt trigger input with CMOS levels; O = output.

Table 2 describes an exemplary embodiment including the various functions that the wireless RF device and digital device package 100 may perform, with the functions arranged by pin dedication. Of course the exact pin and function names used in any particular embodiment or application may vary depending upon the naming convention(s) selected. The embodiment described in Table 2 in general may be suited for applications requiring a wireless RF device 104 and digital device 102 in a 20 pin integrated circuit package 106.

TABLE 2

| | Input/Output/ | BUFFER | |
|---|---|---|---|
| PIN NO./NAME | Power | TYPE | DESCRIPTION |
| 1. V_{DD} | Power | N/A | Positive supply for |
| | | | logic and I/O pins, |
| | | | 2.5 to 5.5 volts. |
| 2. GP5/OSC1/CLKIN | Input/Output | TTL/ST | Bi-directional I/O |
| | | | port/oscillator |
| | | | crystal input/ |
| | | | external clock input. |
| 3. GP4/OSC2 | Input/Output | TTL | Bi-directional I/O |
| | | | port/oscillator |
| | | | crystal output. |
| 4. GP3/˜MCLR/V_{PP} | Input | TTL/ST | Input port/master |
| | | | clear (reset) input/ |
| | | | programming |
| | | | voltage input. |
| 5. XTAL (Xtal OSC) | Input | Xtal OSC | Crystal oscillator |
| | | base | connection. |
| 6. RFEN_{IN} | Input | CMOS | Dual enable for |
| | | | clock buffer and RF |
| | | | (no hysteresis). |
| 7. CLKOUT | Output | CMOS | Crystal Frequency |
| | | | divided by N, e.g., |
| | | | four. |
| 8. PS/DATA_{ASK} | Input | CMOS | Power Select and |
| | | | ASK input. |
| 9. V_{DDRF} | Power | N/A | Radio frequency |
| | | | device power. |
| 10. ANT2 | Output | NPN | Antenna output2. |
| | | Collector | |
| 11. ANT1 | Output | NPN | Antenna output1 |
| | | Collector | |
| 12. V_{SSRF} | Power | N/A | Radio frequency |
| | | | device ground |
| 13. No Connection | N/A | N/A | |
| 14. LF (Loop Filter) | Output | N/A | Common node of |
| | | | charge pump output |
| | | | and VCO steering |
| | | | input, external loop |
| | | | filter connection. |
| 15. DATA_{FSK} | Input | CMOS | Analog switch |
| | | | control input that |
| | | | switches capacitor |
| | | | on/off in xtal osc. |
| | | | circuit for FSK. |
| 16. FSK_{OUT} | Output | CMOS | Connects to FSK |
| | | switch | capacitor, switches |
| | | out | capacitor to ground. |
| 17. GP2/T0CKI | Input/Output | ST | Bi-directional I/O |
| | | | port. Can be |
| | | | configured as |
| | | | T0CKI. |
| 18. GP1 | Input/Output | TTL/ST | Bi-directional I/O |
| | | | port/serial |
| | | | programming clock. |
| 19. GP0 | Input/Output | TTL/ST | Bi-directional I/O |
| | | | port/serial |
| | | | programming data. |
| 20. V_{SS} | Power | N/A | Digital logic and |
| | | | I/O pins ground |

Legend:
TTL = TTL compatible input; I = input; P = power; ST = Schmitt trigger input with CMOS levels; O = output.

Referring to FIG. 3, a schematic circuit diagram of an exemplary embodiment of the invention is illustrated. Typical resistor and capacitor values as well as hookup configurations are depicted in FIG. 3. Four switches 108, 110, 112 and 324 are adapted to control user programmed functions that are transmitted by the RF device 104. A tuned loop antenna 122 may be used for improved transmission range.

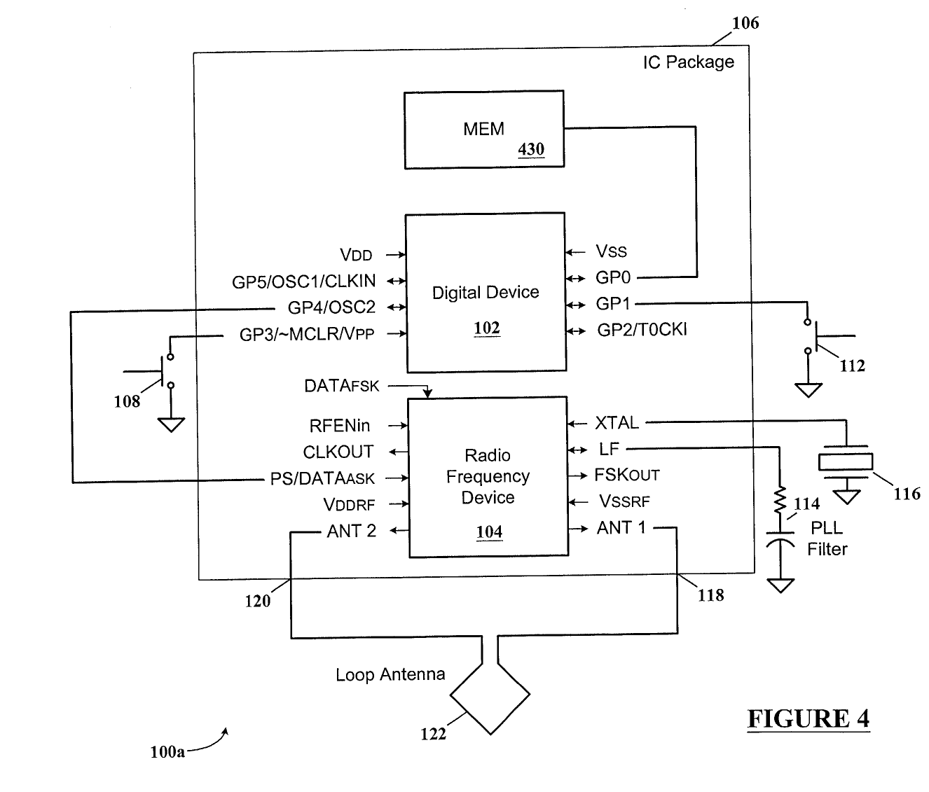

Referring to FIG. 4, depicted is another exemplary embodiment of the present invention having a microelectromechanical (MEM) device. The MEM device 430 is included with the digital device 102 and RF device 104 in the integrated circuit package 106. The MEM device 430 may be for example but not limited to a MagLatch™ switch by Microlab, 341 East Alamo Drive, Chandler, Ariz. 85225. The MEM device 430 may comprise a cantilever, an embedded planar coil, a permanent magnet, and electrical contacts (not illustrated). As an electrical switch, the cantilever is a two-layer composite consisting of a soft magnetic material (e.g., NiFe permalloy) on its topside and a highly conductive material, such as gold, Au, at the bottom surface. The cantilever is supported by torsion flexures from the two sides. The contact end to the right of the cantilever can be deflected up or down by applying a current through the coil. When it is in the “down” position, the cantilever makes electrical contact with the bottom conductors, and the switch is “on” (“closed”); when the contact end is “up”, the switch is “off” (“opened”). The permanent magnet holds the cantilever in either the “up” or the “down” position after switching, making the device a latching relay. Single-pole-double-throw (SPDT) and RF switches can be designed. Latching optical switches can be made based on similar principles.

The principle behind the MagLatch's™ latching characteristics is a preferential magnetization of a cantilever made of soft magnetic material called permalloy. In a constant, nearly perpendicular magnetic field, the cantilever can have either a clockwise or a counter-clockwise torque depending on the angle between the cantilever and the field, which leads to the positional bi-stability. To switch the relay, a second magnetic field generated by a short current pulse (through a coil, in this case) realigns the magnetization of the cantilever and changes the direction of the magnetic torque, causing the cantilever to flip. A static external magnetic field instantly latches the switch in the closed or open position. The switch maintains this state until the next switching signal realigns the cantilever magnetization. The MEM device 430 consumes no power to maintain a latched state.

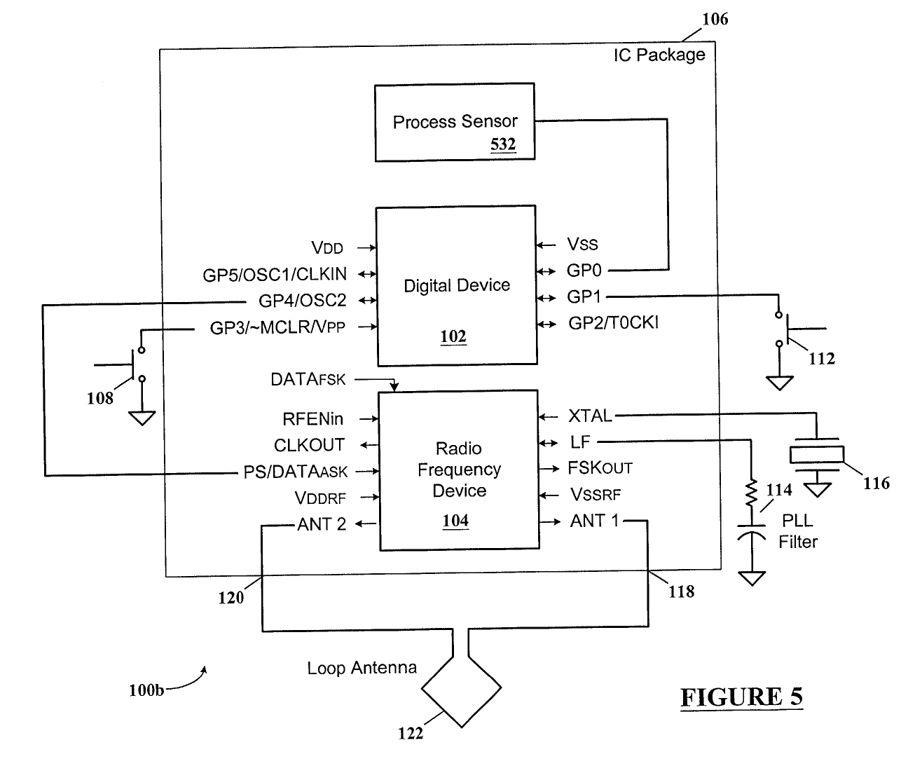

Referring to FIG. 5, depicted is another exemplary embodiment of the present invention having a process sensor included in the package 106. The process sensor 532 may be a MEM device adapted for converting a process input, e.g., pressure, temperature, flow rate, vibration, proximity, etc., into an electrical signal that the digital device 102 can read. This signal may be digital or analog. The package 106 may be adapted for receiving the process input, e.g., a mechanical input orifice, a temperature plate, a pressure pad, etc. The digital device 102 processes the signal from the process sensor 532 and sends the sensor information through the RF device 104 to a receiving station which may display or further process the sensor information. A plurality of sensors 532, MEMs 430 and/or digital inputs or outputs are contemplated for the present invention and are within the scope thereof.

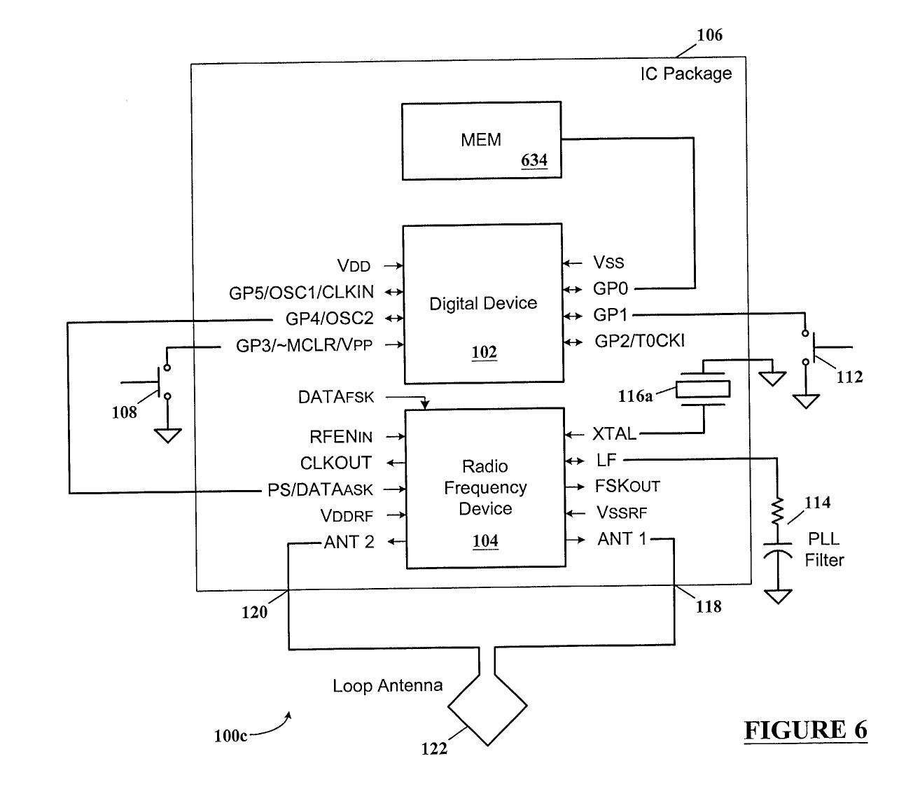

Referring to FIG. 6, depicted is a functional block diagram illustrating still another exemplary embodiment of the present invention having a frequency determining device included in the integrated circuit package. A frequency determining crystal or ceramic resonator 116a may be enclosed in the package 106.

The digital device 102 may be comprised of an application specific integrated circuit (ASIC), a microprocessor, a digital signal processor (DSP), a digital signal controller (DSC), a programmable logic array (PAL), etc.

The present invention has been described in terms of exemplary embodiments. In accordance with the present invention, the parameters for a system may be varied, typically with a design engineer specifying and selecting them for the desired application. Further, it is contemplated that other embodiments, which may be devised readily by persons of ordinary skill in the art based on the teachings set forth herein, may be within the scope of the invention, which is defined by the appended claims. The present invention may be modified and practiced in different but equivalent manners that will be apparent to those skilled in the art and having the benefit of the teachings set forth herein.

No limitations are intended to the details or construction or design shown herein, other than as described in the claims appended hereto. Thus, it should be clear that the specific embodiments disclosed above may be altered and modified, and that all such variations and modifications are within the spirit and scope of the present invention as set forth in the claims appended hereto.

What is claimed is:

1. A wireless digital system in an integrated circuit package, said system comprising:
a digital device;
a wireless device; and
an integrated circuit package, wherein said digital device and wireless device are within said integrated circuit package.

2. The system according to claim 1, wherein the digital device has at least one digital input.

3. The system according to claim 1, wherein the digital device has at least one digital output.

4. The system according to claim 1, wherein the digital device has at least one analog input.

5. The system according to claim 1, wherein the digital device has at least one analog output.

6. The system according to claim 1, wherein:
said digital device has a plurality of bi-directional (GP0-GP5) function input-outputs; and
said wireless device has a RF enable (RFENIN) function input, a crystal frequency (CLKOUT) output, a power select and amplitude shift keying (PS/DATAASK) function input, an antenna (ANT1, ANT2) function output(s), a loop filter (LF) function input-output, and a crystal (XTAL) function input.

7. The system according to claim 6, wherein one of the plurality of bi-directional (GP0-GP5) function input-outputs may be programmed as an oscillator crystal (OSC1) function input.

8. The system according to claim 6, wherein one of the plurality of bi-directional (GP0-GP5) function input-outputs may be programmed as an external clock (CLKIN) function input.

9. The system according to claim 6, wherein one of the plurality of bi-directional (GP0-GP5) function input-outputs may be programmed as an oscillator crystal (OSC2) function output.

10. The system according to claim 6, wherein one of the plurality of bi-directional (GP0-GP5) function input-outputs may be programmed as a master clear (reset) (˜MCLR) function input.

11. The system according to claim 6, wherein one of the plurality of bi-directional (GP0-GP5) function input-outputs may be programmed as a programming voltage (V_{PP}) function input.

12. The system according to claim 6, wherein one of the plurality of bi-directional (GP0-GP5) function input-outputs may be programmed as a (T0CKI) function input.

13. The system according to claim 6, wherein one of the plurality of bi-directional (GP0-GP5) function input-outputs may be programmed as a serial programming clock function input.

14. The system according to claim 6, wherein one of the plurality of bi-directional (GP0-GP5) function input-outputs may be programmed as a serial programming data function input.

15. The system according to claim 1, wherein said wireless device is selected from the group consisting of a radio frequency transmitter, a radio frequency receiver and a radio frequency transceiver.

16. The system according to claim 1, wherein said wireless device is selected from the group consisting of an infrared transmitter, an infrared receiver, and an infrared

17. The system according to claim 1, wherein said wireless device is a radio frequency transmitter and transmitter.

18. The system according to claim 1, wherein said wireless device is selected from the group consisting of an acoustic transmitter, an acoustic receiver, and an acoustic transceiver.

19. The system according to claim 15, wherein said wireless device frequency is determined by a crystal.

20. The system according to claim 15, wherein said wireless device frequency is determined by a ceramic resonator.

21. The system according to claim 19, wherein said crystal controlled wireless device has a voltage controlled oscillator and a phase locked loop.

22. The system according to claim 1, wherein said integrated circuit package is adapted for connections to said digital device and said wireless device.

23. The system according to claim 22, wherein the connections to said digital device are isolated from the connections to said wireless device.

24. The system according to claim 22, wherein the connections for an antenna are toward one end of said integrated circuit package.

25. The system according to claim 22, wherein the connections to said digital device are grouped in a portion of said integrated circuit package and the connections to said wireless device are grouped in another portion of said integrated circuit package.

24. The system according to claim 1, further comprising a micro-electro-mechanical device adapted for connection to said digital device and within said integrated circuit package.

25. The system according to claim 24, wherein said micro-electro-mechanical device is a latching relay.

26. The system according to claim 1, further comprising a process sensor adapted for connection to said digital device and within said integrated circuit package.

27. The system according to claim 26, wherein said process sensor is selected from the sensor group consisting of temperature, pressure, flow rate, vibration, pH, resistance, voltage and current.

28. The system according to claim 26, wherein said process sensor measures analog process variables.

29. The system according to claim 26, wherein said process sensor measures digital process variables.

30. The system according to claim 1, wherein said digital device has read only memory.

31. The system according to claim 30, wherein the read only memory is electrically erasable read only memory.

32. The system according to claim 30, wherein the read only memory is electrically erasable and programmable read only memory.

33. The system according to claim 1, wherein said digital device is a first integrated circuit die and said wireless device is a second integrated circuit die.

34. The system according to claim 1, wherein said digital device encrypts data sent by said wireless device.

35. The system according to claim 1, wherein said digital device and said wireless device have a standby sleep mode to conserve power.

36. The system according to claim 1, wherein said digital device and said wireless device are adapted to be powered from a battery power supply.

37. The system according to claim 22, wherein said digital device and said wireless device have independent power connections and independent ground connections

38. The system according to claim 1, wherein said integrated circuit package is selected from the group consisting of molded plastic dual in-line package (PDIP), ceramic dual in-line package (CERDIP), micro lead frame (MLF); pin grid array (PGA), ball grid array (BGA), quad package; thin packages such as flat packs (FPs), thin small outline package (TSOP), shrink small outline package (SSOP), small outline IC (SOIC), ultrathin package (UTP); lead on chip (LOC) package; and chip on board (COB) package in which the chip is bonded directly to a printed-circuit board (PCB).

39. A method for wireless control of a digital system, said method comprising the steps of:
providing a digital device and a wireless device in an integrated circuit package;
processing input data with the digital device; and
transmitting the processed input data with the wireless device.

40. The method of claim 39, wherein the digital device and the wireless device are powered by a battery power supply.

41. The method of claim 39, further comprising the step of encrypting the input data before transmission.

42. The method of claim 39, wherein the input data is a process variable selected from the group consisting of temperature, pressure, flow rate, vibration, pH, resistance, voltage and current.

43. The system according to claim 1, wherein the digital device is selected from the group consisting of a microcontroller, a microprocessor, a digital signal processor (DSP), an application specific integrated circuit (ASIC), a digital signal controller (DSC), a code hopping encoder, a code hopping decoder, a code hopping encoder-decoder, and a programmable logic array (PAL).

44. The system according to claim 19, wherein said crystal controlled wireless device has a voltage controlled oscillator and a frequency-locked-loop.

45. The system according to claim 1, wherein a signal received by the wireless device is decrypted by the digital device.

46. The system according to claim 1, wherein a signal transmitted by the wireless device is encrypted by the digital device.

47. The system according to claim 1, wherein a frequency determining resonator is located within said integrated circuit package.
